(19) United States
(12) Patent Application Publication
(10) Pub. No.: US 2007/0016946 A1
(43) Pub. Date: Jan. 18, 2007

(54) System and method of querying firewalls

(75) Inventors: Mohamed G. Gouda, Austin, TX (US); Xiang-Yang Alex Liu, Okemas, MI (US)

Correspondence Address: DILLON & YUDELL LLP, 8911 NORTH CAPITAL OF TEXAS HWY, SUITE 2110, AUSTIN, TX, 78759, US

(73) Assignee: University of Texas System

(21) Appl. No.: 11/487,073

(22) Filed: Jul. 14, 2006

Related U.S. Application Data
(60) Provisional application No. 60/699,451, filed on Jul. 15, 2005.

(51) Int. Cl. G06F 15/16

(52) U.S. Cl. 726/11

(57) ABSTRACT

A system, method, and computer-usable medium for firewall query processing. In a preferred embodiment of the present invention, a firewall query manager receives a firewall query and a firewall expressed as a sequence of rules. The firewall query manager first constructs a firewall decision tree from the given sequence of rules. Then the firewall query manager marks all the paths in said firewall decision tree as unprocessed. In response to selecting an unprocessed path for comparison, the firewall query manager computes a partial result by comparing the unprocessed path and the firewall query. In response to determining no more paths among all the paths in said firewall decision tree are to be processed, the firewall query manager computes a final result from at least one partial result.

### PRIORITY CLAIM

The application claims the benefit of priority under 35 U.S.C. §119(e) from U.S. Provisional Application No. 60/699,451, filed on Jul. 15, 2005, which disclosure is incorporated herein by reference.

### BACKGROUND OF THE INVENTION

1. Technical Field

The present invention relates to the field of data processing systems. More particularly, the present invention relates to the field of securing data processing systems. Still more particularly, the present invention relates to a system and method of analyzing firewalls securing data processing systems.

2. Description of Related Art

A firewall is a hardware and/or software network element interposed between a private network and an external network (e.g., Internet) to enforce a desired security policy on all incoming and outgoing packets. A packet can be viewed as a tuple with a finite number of fields; examples of these fields are source/destination IP address, source/destination port number, and protocol type. A firewall configuration defines which packets are legitimate and which are illegitimate with a set of rules. By examining the values of these fields for each incoming and outgoing packet, a firewall differentiates between legitimate and illegitimate packets, accepting legitimate packets and discarding illegitimate packets according to its configuration.

Frequently, firewall configurations include a large number of rules. Due to the large number of rules, understanding and analyzing how a firewall functions has become extremely difficult. The implication of any rule in a firewall cannot be understood without examining all the rules listed about that rule. There are other factors that contribute to the difficulties in understanding and analyzing firewalls. For example, a corporate firewall often includes rules that are written by different administrators at different times and for various reasons. A new firewall administrator has to understand the implication for each rule within a firewall configuration if the firewall administrator was not involved in the original design of the firewall. Therefore, there is a need for a system and method for addressing the aforementioned limitations of the prior art.

### SUMMARY OF THE INVENTION

The present invention includes a system, method, and computer-usable medium for firewall query processing. In a preferred embodiment of the present invention, a firewall query manager receives a firewall query and a firewall expressed as a sequence of rules. The firewall query manager first constructs a firewall decision tree from the given sequence of rules. Then the firewall query manager marks all the paths in said firewall decision tree as unprocessed. In response to selecting an unprocessed path for comparison, the firewall query manager computes a partial result by comparing the unprocessed rule and the firewall query. In response to determining no more paths among all the paths in the said firewall decision tree are to be processed, the firewall query manager computes a final result from at least one partial result.

The above-mentioned features, as well as additional objectives, features, and advantages or the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram depicting an exemplary network in which a preferred embodiment of the present invention may be implemented;

FIG. 2 depicts an exemplary data processing system in which a preferred embodiment of the present invention may be implemented;

FIG. 3 illustrates an exemplary firewall decision tree according to a preferred embodiment of the present invention; and

FIGS. 4A-4B are high-level logical flowchart diagrams depicting an exemplary method of rule-based and FDT-based firewall query processing according to a preferred embodiment of the present invention.

### DETAILED DESCRIPTION OF A PREFERRED EMBODIMENT

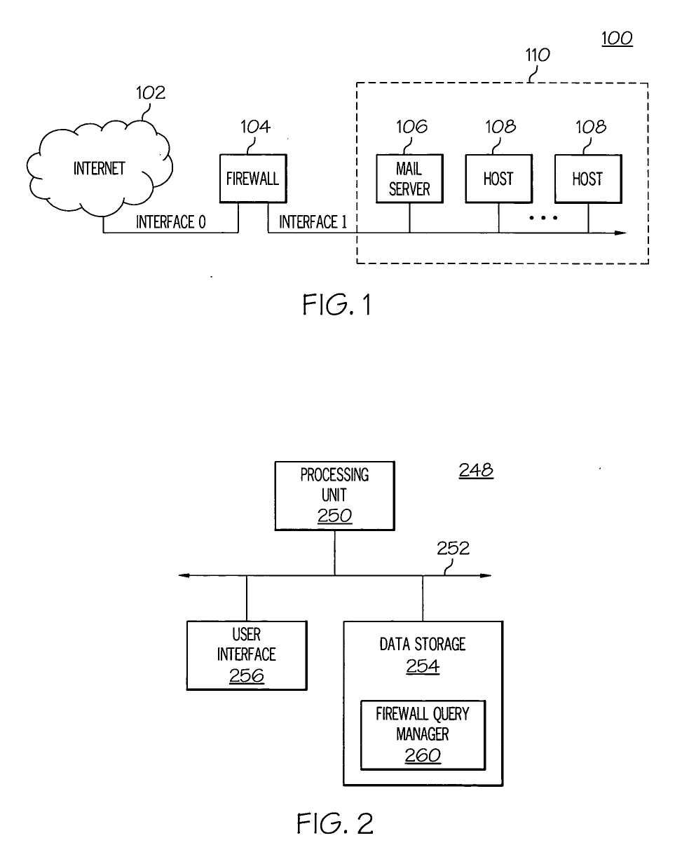

With reference now to the figures, and in particular, with reference to FIG. 1, there is depicted a block diagram illustrating an exemplary network 100 in which a preferred embodiment of the present invention may be implemented. As illustrated, network 100 includes Internet 102, which is coupled to private network 110 via firewall 104. Internet 102 is an interconnect system of networks that connects computers around the world via the transmission control protocol/internet protocol (TCP/IP) protocol suite. Firewall 104 provides secure access to and from private network 110. Particularly, any packet that attempts to enter or leave private network 110 is first examined by firewall 104 and, depending on the settings of the different fields in the packet, firewall 104 determines whether to transmit or discard the packet.

In the depicted embodiment, private network 110 includes a mail server 106 and at least one host 108. If firewall 104 decides to accept an incoming packet, the packet is routed by firewall 104 or an associated router to either mail server 106 or host(s) 108 depending on the setting of the fields of the packet.

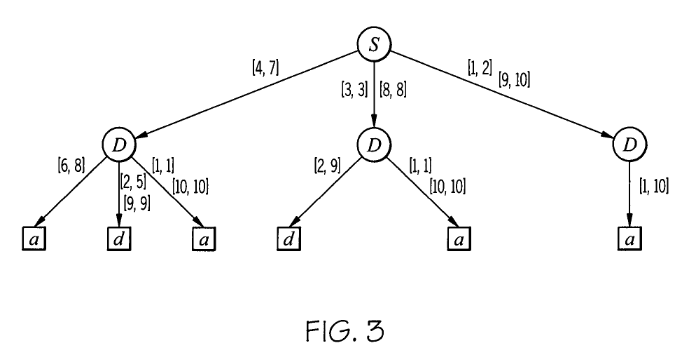

FIG. 2 is a block diagram depicting an exemplary data processing system 248 in which a preferred embodiment of the present invention may be implemented. Those with skill in the art will appreciate that firewall 104, mail server 106, or host(s) 108 may be implemented with a data processing system 248. Also, those with skill in the art will appreciate that the present invention is not limited to the representation of data processing system 248 illustrated in FIG. 2, but may include any type of single or multi-processor data processing system.

As illustrated, data processing system 248 includes processing unit 250, data storage 254, and user interface 256, which are all coupled by interconnect 252. Data storage may be implemented by any type of volatile or non-volatile memory such as read-only memory (ROM), random-access memory (RAM), any type of flash memory, optical memory, and magnetic storage. Also, as depicted, data storage 254 includes firewall query manager 260, discussed herein in more detail.

### DEFINITIONS

A “packet” is defined over the fields F₁ . . . , F_{d} as a d-tuple (p₁ . . . , p_{d}) where each pᵢ is an element in the domain D(Fᵢ) of field Fᵢ, and each D(Fᵢ) is an interval of nonnegative integers. For example, one of the fields of an IP packet is the source address, and the domain of this field is [0,2³²). For the brevity of presentation, we assume that all packets are over the d fields F₁ . . . , F_{d}, and we use Σ to denote the set of all packets. It follows that Σ is a finite set of size |D(F₁)|x . . . x|D(F_{d})|.

A “firewall” consists of a sequence of rules, where each rule is of the following format: (F₁ ∈ S₁) [symbol] . . . [symbol] (F_{d} ∈ S_{d})→<decision> where each Sᵢ is a nonempty subset of D(Fᵢ), and the <decision> is either accept or discard. If Sᵢ=D(Fᵢ), we can replace (Fᵢ ∈ Sᵢ) by (Fᵢ ∈ all), or remove the conjunct (Fᵢ ∈ D(Fᵢ)) altogether. A packet (p₁ . . . , p_{d}) matches a rule (F₁ ∈ S₁) [symbol] . . . [symbol] (F_{d} ∈ S_{d})→<decision> if and only if the condition (p₁ ∈ S₁) [symbol] . . . [symbol] (p_{d} ∈ S_{d}) holds. Since a packet may match more than one rule in a firewall, each packet is mapped to the decision of the first rule that the packet matches. The predicate of the last rule in a firewall is usually a tautology to ensure that every packet has at least one matching rule in the firewall.

An example of a simple firewall, according to a preferred embodiment of the present invention is as follows: assuming that each packet only has two fields: S (source address) and D (destination address), and both fields have the same domain [1, 10]. This firewall consists of the sequence of rules in as follows. Let f₁ be the name of this firewall:
r₁: S ∈ [4,7] [symbol] D ∈ [6,8]→accept
r₂: S ∈ [3,8] [symbol] D ∈ [2,9]→discard
r₃: S ∈ [1,10] [symbol] D ∈ [1,10]→accept
   Query Language

A query, denoted Q, in our Structured Firewall Query Language (SFQL) is of the following format:

select Fᵢ

from f

where (F₁ ∈ S₁) [symbol] . . . [symbol] (F_{d} ∈ S_{d}) [symbol] (decision=<dec>)

where Fᵢ is one of the fields F₁, . . . , F_{d}, f is a firewall, each Sⱼ is a nonempty subset of the domain D(Fⱼ) of field Fⱼ, and <dec> is either accept or discard.

The result of query Q, denoted Q.result, is the following set:

{pᵢ|(p₁, . . . p_{d}) is a packet in Σ, and
(p₁ ∈ S₁) [symbol] . . . [symbol] (p_{d} ∈ S_{d}) [symbol] (f.(p₁, . . . , p_{d})=<dec>)}

As previously discussed, Σ denotes the set of all packets, and f. (p₁, . . . , p_{d}) denotes the decision to which firewall f maps the packet (p₁, . . . p_{d}). The above set can be obtained by first finding all the packets (p₁, . . . , p_{d}) in Σ such that the following condition holds:
(p₁ ∈ S₁) [symbol] . . . [symbol] (p_{d} ∈ S_{d}) [symbol] (f((p₁, . . . , p_{d}))=<dec>)
and projecting all these packets to the field Fᵢ.

For example, a question to the firewall f₁, “Which computers whose addresses are in the set [4,8] can send packets to the machine whose address is 6?”, can be formulated as the following query using SFQL:

select S

from f₁

where (S ∈ {[4,8]}) [symbol] (D ∈ {6}) [symbol] (decision=accept)

The result of this query is {4, 5, 6, 7}.

As another example, a question to the firewall f₁, “Which computer cannot send packets to the computer whose address is 6?”, can be formulated as the following query using SFQL:

select S

from f₁

where (S ∈ {[all]}) [symbol] (D ∈ {6}) [symbol] (decision=discard)

The result of this query is {3, 8}.

Firewall Query Examples

Let f be the name of the firewall that resides on the gateway router depicted in FIG. 1. This gateway router has two interfaces: interface 0, which connects the gateway router to the outside Internet, and interface 1, which connects the gateway router to the inside local network. In these examples, we assume each packet has the following five fields: I (Interface), S (Source IP), D (Destination IF), N (Destination Port), P (Protocol Type).

Question 1:

Which computers in the private network protected by the firewall f can receive BOOTP² packets from the outside Internet?

Query Q₁:

select D

from f

where (I ∈ {[0]}) [symbol] (S ∈ {all}) [symbol] (D ∈ {all}) [symbol] (N ∈ {67,68}) [symbol] (P ∈ {udp}) [symbol] (decision=accept)

Answer to question 1 is Q₁.result.

Question 2:

Which ports on the mail server protected by the firewall f are open?

Query Q₂:

select N

from f

where (I ∈ {[0,1]}) [symbol] (S ∈ {all}) [symbol] (D ∈ {Mail_Server}) [symbol] (N ∈ {all}) [symbol] (P ∈ {all}) [symbol] (decision=accept)

Answer to question 2 is Q₂.result.

Question 3:

Which computers in the outside Internet cannot send SMTP packets to the mail server protected by the firewall f?

Query Q₃:

select S

from f

where (I ∈ {0}) [symbol] (S ∈ {all}) [symbol] (D ∈ {Mail_Server}) [symbol] (N ∈ {25}) [symbol] (P ∈ {tcp}) [symbol] (decision=discard)

Answer to question 3 is Q₃.result.

Question 4:

Which computers in the outside Internet cannot send any packet to the private network protected by the firewall f?

Query Q₄:

select S

from f

where (I ∈ {0}) [symbol] (S ∈ {all}) [symbol] (D ∈ {all}) [symbol] (N ∈ {all}) [symbol] (decision=accept)

Answer to question 4 is T-Q₄.result, where T is the set of all IP addresses outside of the private network

Question 5:

Which computers in the outside Internet can send SMTP packets to both host 1 and host 2 in the private network protected by the firewall f?

Query Q₅ₐ:

select S

from f

where (I ∈ {0}) [symbol] (S ∈ {all}) [symbol] (D ∈ {Host_1}) [symbol] (N ∈ {25}) [symbol] (P [symbol] {tcp}) [symbol] (decision=accept)

Query Q_{5b}:

select S

from f

where (I ∈ {0}) [symbol] (S ∈ {all}) [symbol] (D ∈ {Host_2}) [symbol] (N ∈ {25}) [symbol] (P [symbol] {tcp}) [symbol] (decision=accept)

Answer to question 5 is Q₅ₐ.result∩Q_{5b}.result.

Firewall Query Processing

Consistent firewalls and inconsistent firewalls are defined as follows:

Definition 1 (Consistent Firewalls): A firewall is called a consistent firewall if any two rules in the firewall do not conflict.

Definition 2 (Inconsistent Firewalls): A firewall is called an inconsistent firewall if there are at least two rules in the firewall that conflict.

Recall that two rules in a firewall conflict if and only if they have different decisions and there is at least one packet that can match both rules. For example, the first two rules in the firewall f₁, namely r₁ and r₂, conflict. Note that for any two rules in a consistent firewall, if they overlap, i.e., there is at least one packet can match both rules, they have the same decision. So, given a packet and a consistent firewall, all the rules in the firewall that the packet matches have the same decision. Firewall f₁ is an example of an inconsistent firewall, and firewall f₂ (shown below) is an example of a consistent firewall. In these two firewall examples, it is assumed that each packet only has two fields: S (source address) and D (destination address), and both fields have the same domain [1, 10].

Firewall f₂:

| | | |
|---|---|---|
| r′₁: S ε [4, 7] | [symbol] D ε [6, 8] | → a |
| r′₂: S ε [4, 7] | [symbol] D ε [2, 5] ∪ [9, 9] | → d |
| r′₃: S ε [4, 7] | [symbol] D ε [1, 1] ∪ [10, 10] | → a |
| r′₄: S ε [3, 3] ∪ [8, 8] | [symbol] D ε [2, 9] | → d |
| r′₅: S ε [3, 3] ∪ [8, 8] | [symbol] D ε [1, 1] ∪ [10, 10] | → a |
| r′₆: S ε [1, 2] ∪ [9, 10] | [symbol] D ε [1, 10] | → a |

First, each inconsistent firewall can be converted to an equivalent consistent firewall, as discussed herein in more detail. Second, as shown in the following theorem, it is easier to process queries for consistent firewalls than for inconsistent firewalls.

Theorem 1 (Firewall Query Theorem) Let Q be a query of the following form:

select Fᵢ

from f

where (F₁ ∈ S₁) [symbol] . . . [symbol] (F_{d} ∈ S_{d}) [symbol] (decision=<dec>)
If f is a consistent firewall that consists of n rules r₁, . . . rₙ, then we have

$$Q . result = {{⋃}^{n}}_{j = 1} Q . {r}_{j}$$

where each rule rⱼ is of the form
(F₁ ∈ S′₁) [symbol] . . . [symbol] (F_{d} ∈ S_{d}) [symbol] (decision=<dec′>)
and the quantity of Q.rⱼ is defined as follows:

$$Q . {r}_{j} \{ \begin{matrix}{S}_{i} ⋂ {S}_{i}^{′} & if ( {S}_{1} ⋂ {S}_{1}^{′} \neq ϕ ) ⋀ … ⋀ ( {S}_{d} ⋂ {S}_{d}^{′} \neq ϕ ) ⋀ ( 〈 dec 〉 = 〈 {dec}^{′} 〉 ) , \\ ϕ & otherwise\end{matrix}$$

The Firewall Query Theorem implies a simple query processing algorithm: given a consistent firewall f that consists of n rules r₁, . . . , rₙ, and a query Q, compute Q.rⱼ for each j, then

$${⋃}_{j = 1}^{n} Q . {r}_{j}$$

is the result of query Q. This algorithm is referred to as “the rule-based firewall query processing” algorithm:
Rule-Based Firewall Query Processing Algorithm
Input: (1) A consistent firewall f that consists of n rules: r₁, . . . rₙ,

(2) A query Q:
select Fᵢ
from f
where (F₁ ∈ S₁) [symbol] . . . [symbol] (F_{d} ∈ S_{d}) [symbol] (decision=<dec>)
   Output: Result of Query Q
   Steps:
1. Q.result:=Ø;
2. for j:=1 to n do/* Let rⱼ=(F₁ ∈ S′₁) [symbol] . . . [symbol] (F_{d} ∈ S′_{d})→<dec′>*/ if (S₁ ∩ S′₁≠ø) [symbol] . . . [symbol] (S_{d} ∩ S′_{d}≠ø) [symbol] (<dec>=<dec′>), then Q.result:=Q.result∪(Sᵢ ∩ S′ᵢ);
3. return Q.result
   FDT-Based Firewall Query Processing Algorithm

Observe that multiple rules in a consistent firewall may share the same prefix. For example, in the consistent firewall f₂, the first three rules, namely r′₁, r′₂, r′₃, share the same prefix S ∈ [4,7]. Thus, if the above query processing rule-based firewall query algorithm is applied to answer a query, for instance, whose “where clause” contains the conjunct S ∈ {3}, over the firewall f₂, then the algorithm will repeat three times the calculation of {3}∩[4, 7]. Clearly, repeated calculations are not desirable for efficiency purposes.

A firewall query processing method that has no repeated calculations and can be applied to both consistent and inconsistent firewalls. The firewall query processing method includes two steps. First, convert the firewall (whether consistent or inconsistent) to an equivalent firewall decision tree (short for FDT). Second, use this FDT as the core data structure for processing queries. We call the algorithm that uses an FDT to process queries the FDT-based firewall query processing algorithm. Firewall decision trees are defined as follows. Note that firewall decision trees are a special type of firewall decision diagrams that are useful notations for specifying firewalls.

Definition 3 (Firewall Decision Tree): A Firewall Decision Tree t over fields F₁, . . . , F_{d} is a directed tree that has the following four properties:
1. Each node v in t has a label, denoted F(v), such that

$$F ( v ) ∈ \{ \begin{matrix}\{ {F}_{1} , … , {F}_{d} \} & if v is nonterminal , \\ \{ accept , discard \} & if v is terminal .\end{matrix}$$
2. Each edge e in t has a label, denoted I(e), such that if e is an outgoing edge of node v, then I(e) is a nonempty subset of D(F(v)).
3. A directed path in t from the root to a terminal node is called a decision path of t. Each decision path contains d nonterminal nodes, and the i-th node is labelled Fᵢ for each i that 1≦i≦d.
4. The set of all outgoing edges of a node v in t; denoted E(v), satisfies the following two conditions:

(a) Consistency: I(e)∩I(e′)=φ for any two distinct edges e and e′ in E(v),

(b) Completeness:

$${⋃}_{e ∈ E ( v )} I ( e ) = D ( F ( v ) )$$

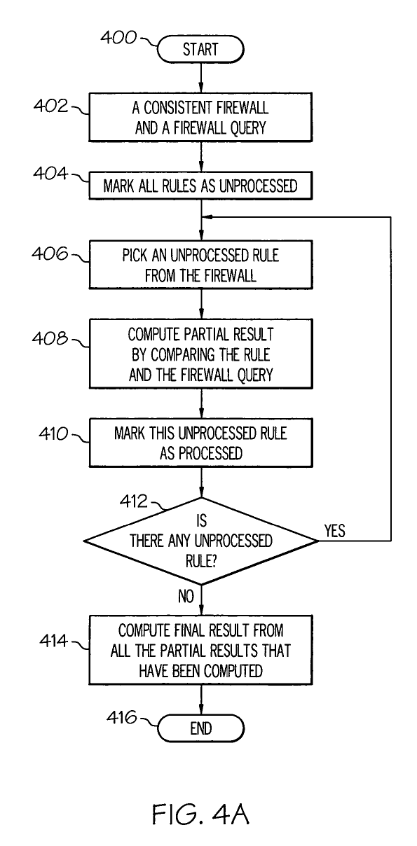

FIG. 3 illustrates an example of an FDT named t₃. In this example, assume that each packet only has two fields: S (source address) and D (destination address), and both fields have the same domain [1, 10]. Hereinafter, including this example, “a” represents accept and “d” represents discard.

A decision path in an FDT t is represented by (v₁e₁ . . . v_{d}e_{d}v_{d+1}) where v₁ is the root, V_{d+1} is a terminal node, and each e is a directed edge from node vᵢ to node vᵢ₊₁. A decision path (v₁e₁ . . . v_{d}e_{d}v_{d+1}) in an FDT defines the following rule:
F₁ ∈ S₁ [symbol] . . . [symbol] F_{d} ∈ S_{d}→F(v_{d+1})
Where Sᵢ=I(eᵢ)

For an FDT t, Γ (t) denotes the set of all the rules defined by all the decision paths of t. For any packet p, there is one and only one rule in Γ(t) that p matches because of the consistency and completeness properties; therefore, t maps p to the decision of the only rule that p matches in Γ(t). Considering the FDT t₃ in FIG. 3, firewall f₁ shows all the six rules in Γ(t₃).

Given an FDT t, any sequence of rules that consists of all the rules in Γ(t) is equivalent to t. The order of the rules in such a firewall is immaterial because the rules in Γ(t) are non-overlapping. Given a sequence of rules, an equivalent FDT can be constructed. Therefore, an inconsistent firewall can be converted to an equivalent consistent firewall utilizing the following two steps: first, construct an equivalent FDT from the original inconsistent firewall; second, generate one rule for each decision path of the FDT. Then any sequence that consists of all the rules defined by the decision paths of the FDT is the resulting equivalent consistent firewall.

The pseudocode of the FDT-based firewall query processing algorithm is shown as follows. Here e.t denotes the (target) node that the edge e points to, and t.root denotes the root of FDT t.

FDT-based Firewall Query Processing Algorithm
Input: (1) An FDT t

(2) A query Q: select Fᵢ
from t
where (F₁ ∈ S₁) [symbol] . . . [symbol] (F_{d} ∈ S_{d}) [symbol] (decision=<dec>)
   Output: Result of query Q
   Steps:

(1) Q.result:=Ø;

(2) CHECK(t.root, (F₁ ∈ S₁) [symbol] . . . [symbol] (F_{d} ∈ S_{d}) [symbol] (decision=<dec>))

(3) return Q.result;

CHECK(v, (F₁ ∈ S₁) [symbol] . . . [symbol] (F_{d} ∈ S_{d}) [symbol] (decision=<dec>))

1. if (v is a terminal node) and (F(v)=<dec>))

(1) Let (F₁ ∈ S′₁) [symbol] . . . [symbol] (F_{d} ∈ S′_{d}) [symbol] (decision=<dec′>) be the rule defined by the decision path containing node v;

(2) Q.result:=Q.result∪(Sᵢ∩S′ᵢ);
2. If (v is a nonterminal node) then /* Let Fⱼ be the label of v*/ for each edge e in E(v) do

If I(e)∩Sⱼ≠φ then
CHECK(e.t, (F₁ ∈ S₁) [symbol] . . . [symbol] (F_{d} ∈ S_{d}) [symbol] (decision=<dec>))

The above FDT-based firewall query processing algorithm has two inputs, an FDT t and an SFQL query Q. The algorithm starts by traversing the FDT from its root. Let Fⱼ be the label of the root. For each outgoing edge e of the root, I(e)∩Sⱼ. If I(e)∩Sⱼ=φ is computed, skip edge e, and do not traverse the subgraph that e points to. If I(e)∩Sⱼ≠φ continue to traverse the subgraph that e points to in a similar fashion. Whenever a terminal node is encountered, compare the label of the terminal node and <dec>. If the label of the terminal node and <dec> are the same, assuming the rule defined by the decision path containing the terminal node is (F₁ ∈ S′₁) [symbol] . . . [symbol] (F_{d} ∈ S′_{d})→<dec′>, then Sᵢ∩S′₁, is added to Q.result.

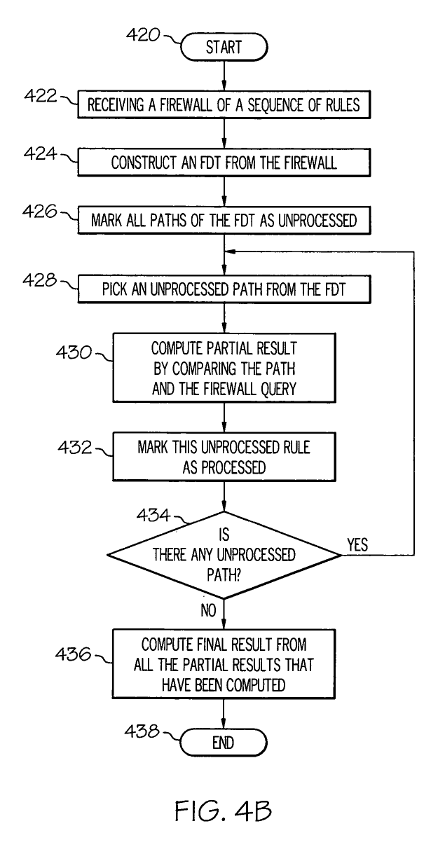

FIGS. 4A-4B is a high-level logical flowchart diagram illustrating an exemplary method of rule-based firewall query processing according to a preferred embodiment of the present invention. The process begins at step 400 and proceeds to step 402, which illustrates firewall query manager 260 receiving a consistent firewall and a firewall query. The process continues to step 404, which illustrates firewall query manager 260 marking all rules that make up the consistent firewall as unprocessed. The process continues to steps 406 and 408, which depict firewall query manger 260 picking an unprocessed rule from the firewall and computing a partial result by comparing the rule and the firewall query. The process proceeds to step 410, which illustrates firewall query manager 260 marking the rule as processed.

Firewall query manager 260 makes a determination as to whether any unprocessed rules remain, as depicted in step 412. If any unprocessed rules remain, the process returns to step 406 and proceeds in an iterative fashion. If no more unprocessed rules remain, the process continues to step 414, which illustrates firewall query manage 260 computing a final result from the partial results. The process ends, as depicted in step 416.

FIG. 4B is a high-level logical flowchart diagram depicting an exemplary method for FDT-based firewall query processing according to a preferred embodiment of the present invention. The process begins at step 420 and proceeds to step 422, which illustrates firewall query manager 260 receiving a firewall of a sequence of rules. The process proceeds to step 424, which depicts firewall query manager 260 constructing a firewall decision tree from the received firewall. The process continues to step 426, which illustrates firewall query manager 260 marking all paths of the firewall decision tree as unprocessed. The process proceeds to steps 428-432, which depict firewall query manager 260 picking an unprocessed path from the firewall decision tree, computing a partial result by comparing the chosen, unprocessed path and the firewall query, and marking the formally-unprocessed path as a processed path.

The process continues to step 434, which illustrates firewall query manager 260 determining if there are any remaining unprocessed paths. If there are remaining unprocessed paths, the process returns to step 428 and proceeds in an iterative fashion. If there are no more remaining unprocessed paths, the process continues to step 436, which depict firewall query manager 260 computing a final result from all the partial results that have been completed. The process ends, as illustrated in step 438.

As discussed, the present invention includes a system, method, and computer-usable medium for firewall query processing. In a preferred embodiment of the present invention, a firewall query manager receives a firewall query and a firewall expressed as a sequence of rules. The firewall query manager first constructs a firewall decision tree from the given sequence of rules. Then the firewall query manager marks all the paths in said firewall decision tree as unprocessed. In response to selecting an unprocessed path for comparison, the firewall query manager computes a partial result by comparing the unprocessed path and the firewall query. In response to determining no more paths among all the paths in the said firewall decision tree are to be processed, the firewall query manager computes a final result from at least one partial result.

As disclosed, the present invention includes a system and method of querying firewalls to analyze the function of an existing firewall. Also, it should be understood that at least some aspects of the present invention may be alternatively implemented in a computer-readable medium that stores a program product. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method for firewall query processing, said method comprising:
receiving a firewall query and a consistent firewall expressed as a sequence of rules;
marking all rules in said sequence of rules as unprocessed;
in response to selecting an unprocessed rule for comparison, computing a partial result by comparing said unprocessed rule and said firewall query; and
in response to determining no more rules among said sequence of rules are to be processed, computing a final result from at least one said partial result.

2. The method according to claim 1, further comprising:
constructing a firewall decision tree, wherein said firewall decision tree includes a plurality of paths, from said firewall;
marking all of said plurality of paths within said firewall decision tree as unprocessed;
in response to selecting an unprocessed path for comparison, computing a partial result by comparing said unprocessed path and said firewall query; and
in response to determining no more paths among said firewall decision tree are to be processed, computing a final result from at least one said partial result.

3. A system for firewall query processing, said system comprising:
a processor;
a data bus coupled to said processor; and
a computer-usable medium embodying computer program code, said computer-usable medium being coupled to said data bus, said computer program code comprising instructions executable by said processor and configured for:
receiving a firewall query and a consistent firewall expressed as a sequence of rules;
marking all rules in said sequence of rules as unprocessed;
in response to selecting an unprocessed rule for comparison, computing a partial result by comparing said unprocessed rule and said firewall query; and
in response to determining no more rules among said sequence of rules are to be processed, computing a final result from at least one said partial result.

4. The system according to claim 3, wherein said instructions are further configured for:
constructing a firewall decision tree, wherein said firewall decision tree includes a plurality of paths, from said firewall;
marking all of said plurality of paths within said firewall decision tree as unprocessed;
in response to selecting an unprocessed path for comparison, computing a partial result by comparing said unprocessed path and said firewall query; and
in response to determining no more paths among said firewall decision tree are to be processed, computing a final result from at least one said partial result.

5. A computer-usable medium embodying computer program code, said computer program code comprising computer-executable instructions configured for:
receiving a firewall query and a consistent firewall expressed as a sequence of rules;
marking all rules in said sequence of rules as unprocessed;
in response to selecting an unprocessed rule for comparison, computing a partial result by comparing said unprocessed rule and said firewall query; and
in response to determining no more rules among said sequence of rules are to be processed, computing a final result from at least one said partial result.

6. The computer-usable medium according to claim 5, wherein said embodied computer program code further comprises computer executable instructions configured for:
constructing a firewall decision tree, wherein said firewall decision tree includes a plurality of paths, from said firewall;
marking all of said plurality of paths within said firewall decision tree as unprocessed;
in response to selecting an unprocessed path for comparison, computing a partial result by comparing said unprocessed path and said firewall query; and
in response to determining no more paths among said firewall decision tree are to be processed, computing a final result from at least one said partial result.
